(19) United States
(12) Patent Application Publication
(10) Pub. No.: US 2009/0089948 A1
(43) Pub. Date: Apr. 9, 2009

(54) Katy

(76) Inventors: Chikezie Ottah, Brooklyn, NY (US); Kenneth Ottah, Enugu (NG); Chika Ottah, Enugu (NG); Chineye Ottah, Enugu (NG)

Correspondence Address: CHIKEZIE OTTAH, 1035 CLARKSON AVENUE, SUITE 5A, BROOKLYN, NY, 11212, US

(21) Appl. No.: 11/973,217

(22) Filed: Oct. 9, 2007

(51) Int. Cl. B08B 1/00; A47K 7/02

(52) U.S. Cl. 15/104.93; 15/210.1

(57) ABSTRACT

The cleaning aid 77 is use during a bowel, or urinary discharge 30. The invention is assembled to provide gel, or jelly 20 smooth anal, and or vaginal squats, or bending swiping cleaning. The invention provide to the 20 user moisture, wet, 16 vacuum, 18 dry, tissue, plastic, rag, towel, and wiper. To 7 give the user full control, 5 there is electrical buttons 6 for proper cleaning. The invention provides also manual equipment.

### BACKGROUND OF INVENTION

The disclosed invention relate to personal hygiene after bowel and urinary discharge. The invention can be in two patterns, a hand held and a standing type. It is use to clean the anal canal after bowel discharge. The present invention is not funded by federally sponsored research and does not relate to any prior application.

### SUMMARY OF INVENTION

The new invention is made from the assembles of metal, Bronze, copper, zippers, buttons, brackets, screws, leather, nuts, tissue, silicone gel, silicon jelly, towel, rag, cloth, wiper, paper plastic and rubber.

Another objective of the present invention is to make personal cleaning and hygiene fast and easy after bowel discharge to everyone.

Another objective of the present invention is to improve privacy of patient and care givers.

The current invention intends to eliminate irritation after bowel and urinary discharge.

Another objective of this invention is to assist those physically challenged to archive self sufficient in personal cleaning after bowel and urinary discharge.

Another objective of the of the current invention is to assist elders and also achieve a high level of self sufficiency.

Another objective of this invention is to educate children on personal hygienic methods and to handle private body part after bowl discharge.

The invention provides equal access to sanitary and hygienic cleanliness after bowl or urinary discharge. Both indoor and outdoor

### BRIEF DESCRIPTION OF THE DRAWING

FIG. 1 is an exploded view of the present invention.

FIG. 2 Schematic perspective view of FIG. 2

FIG. 3 is side elevated view of the cleaning aid according to the embodiment of the present invention.

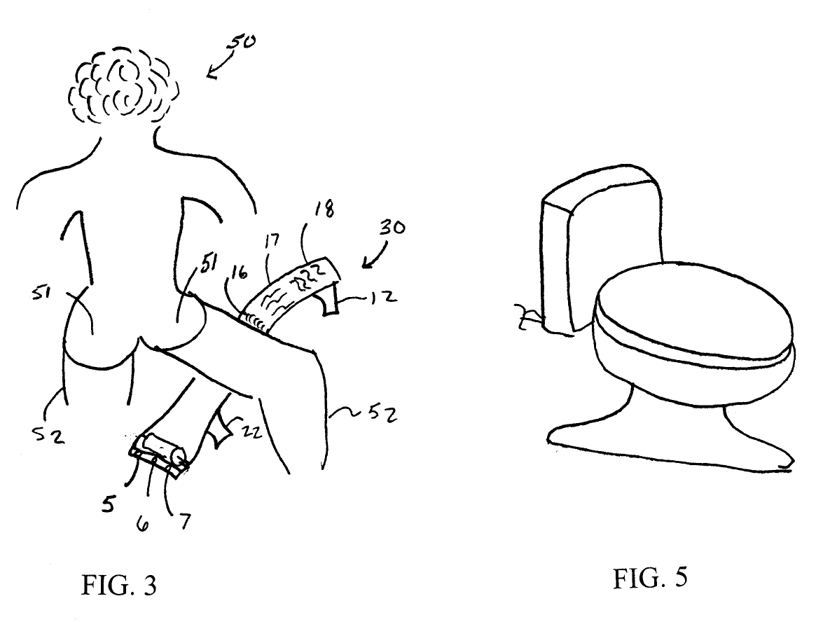

FIG. 4 Schematic perspective view of FIG. 4

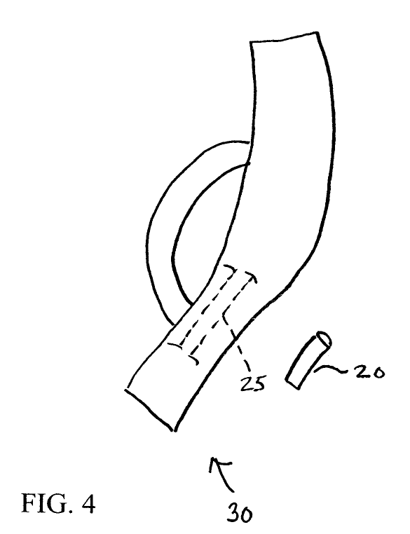

### DETAILED DESCRIPTION OF THE INVENTION

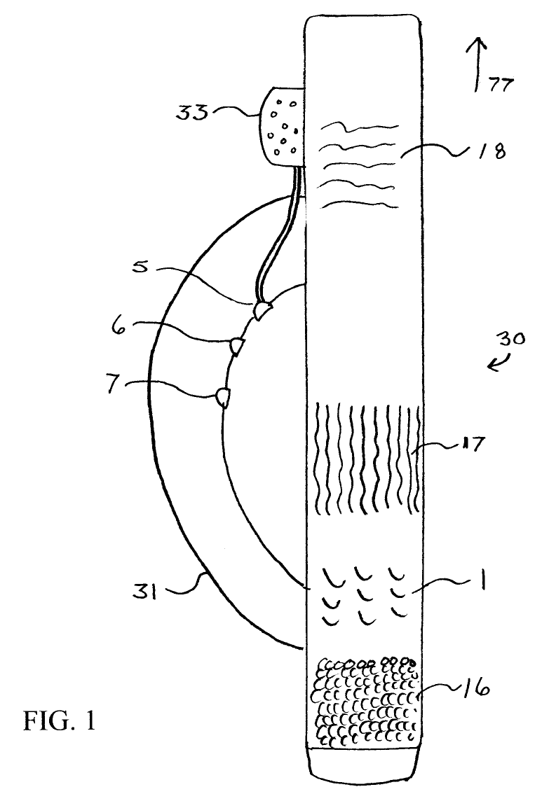

The present invention as described in FIG. 1 30 is the hand held, Katy personal cleaning; 31 is the invention handle. The hand is used to circulate moisture or liquid 5, the middle button absorbed the dissolved waste 6 by vacuuming and 7 releasing the soiled tissue, rag, cloth, plastic, leather or wiper for ejection.

The location 33 of the liquid, the liquid container can be located on either end and can be held or applied.

FIG. 1 has a layer of silicon jelly, foam inbuilt to replicate 20 and reshape to fit each individual curves, some tubs are connected at this level to sprinkle water, not shown.

The material like mesh 16 is the wet area, alternately 16 would be plain, 1 absorbed the wet created 16 in a form of vacuum. As the individual slide the invention between the legs (anal) to 17 dry all moisture, 18 when the cleaning and drying finished, the rag, tissue, cloth, or wipe is ejected using the handle method in invention.

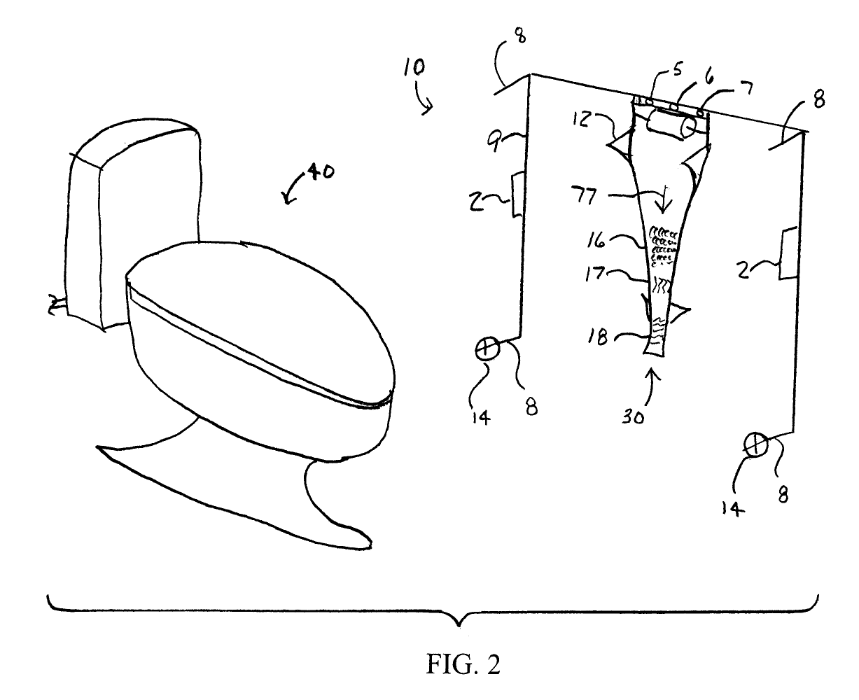

FIG. 2 illustrate the elevated standing Katy, 10 the user squat and 77 slide their bottom down 30.

After bowel discharge, 9 the individual step into the box, 2 holding the hand rail 77 as the individual squat onto 30.

The box 9 like shape has legs and 14 the wheels to move Katy into any position closer to 40 the toilets bowl.

this illustrates another type of Katy. It can be assembled in many shapes and sizes to fit an individual's need. Square, rectangular round, 10 the material to make Katy includes plastic, wood, rubber, metal, aluminum, screws, nuts, bolts, brackets, belts, zips, leather, cloths, mesh, tissue, rags, 10 wiper and buttons.

Still illustrating sample 2, 10 FIG. 2. Referring to 10 the rag, tissue, plastic, paper, wiper which unroll to cover 77 the invention. 30

Rag, 16, plastic, paper, wiper and tissue are to be rolled 20 in a loop 17 and 18 to the tip of the device, it is glued, taped or clipped to the invention 30. Not shown.

This are 30 the materials under the wiper, rag, and tissue, 16 metal, copper, silicon, jelly or jell, soft foam, plastic, or 17, 18 rubber for easy cleaning after of the surface after use.

Continue reference 77, there 5 is a control button to release moisture or liquid to 16 the rag or tissue. excess moisture 6 are absorbed or vacuum when button at middle is press 7.

Sample 3 illustrate fig . . . , 50 the user, 52 spread legs 77 after the invention and squat sliding 30 towards 16 the moisture rag, plastic, tissue, and paper 17 the motion continues until the moisture was absorbed or vacuumed, 18 and dry towel 51 the procedure can be repeated to the satisfaction of 50 the user. Unscrew 16, 17 and 18 the invention

Referring to fig. the invention Could be turned into outdoor urinary container.

Referring 77 to FIG. 5 the button that releases moisture to the 16 rag. The moisture is 17 absorbed or vacuum and the soil wiper is then cut and ejected from the invention, the cutter in not shown.

Refer to 30 is the assemble of silicon jell or jelly to simply 51 replica the shapes and curve of the 50 user, as 50 the user lower in squat sliding 30 toward the slop rag.

51 the wheels position adjust for the cleaning 51 the anus. 12 are the legs on the floor where every part of Katy rest on.

The samples demonstrate another 30 type of the 77 Katy, or the invention 20 the tissue, rag, wiper, cloth, leather are in a loop, holder is in a detachable form 25. All sample of the invention can be used inside and outside for urinary discharge.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. A cleaning aid for use after bowel and urinary discharge comprising, in combination:
a surface to be covered by a soil wiper; and
a liquid container operably connected to the surface to selectively release liquid to at least a portion of the soil wiper on the surface.

13. The cleaning aid according to claim 12, further comprising a user-activated button for selectively releasing liquid from the liquid container to the soil wiper.

14. The cleaning aid according to claim 1, further comprising a vacuum for removing excess liquid released from the liquid container.

15. The cleaning aid according to claim 14, further comprising a user-activated button for selectively activating the vacuum.

16. The cleaning aid according to claim 14, wherein the vacuum is battery powered.

17. The cleaning aid according to claim 1, further comprising a user-activated button for selectively ejecting the soil wiper from the surface.

18. The cleaning aid according to claim 1, wherein the soil wiper comprises at least one of tissue, plastic, paper, and cloth.

19. The cleaning aid according to claim 1, wherein the surface deforms to conform with the contour and shape of the user.

20. The cleaning aid according to claim 1, wherein the cleaning aid is configured as a hand held device and includes a handle.

21. The cleaning aid according to claim 1, wherein the cleaning aid is configured as a standing device and includes a frame having legs supporting the frame on the ground and wherein the surface is supported by the frame.

22. A cleaning aid for use after bowel and urinary discharge comprising, in combination:
a surface to be covered by a soil wiper; and
wherein the surface deforms to conform with the contour and shape of the user.

23. The cleaning aid according to claim 22, further comprising a liquid container operably connected to the surface to selectively release liquid to at least a portion of the soil wiper on the surface.

24. The cleaning aid according to claim 23, further comprising a user-activated button for selectively releasing liquid from the liquid container to the soil wiper.

25. The cleaning aid according to claim 23, further comprising a vacuum for removing excess liquid released from the liquid container.

26. The cleaning aid according to claim 25, further comprising a user-activated button for selectively activating the vacuum.

27. The cleaning aid according to claim 25, wherein the vacuum is battery powered.

28. The cleaning aid according to claim 22, further comprising a user-activated button for selectively ejecting the soil wiper from the surface.

29. The cleaning aid according to claim 22, wherein the soil wiper comprises at least one of tissue, plastic, paper, and cloth.

30. The cleaning aid according to claim 22, wherein the cleaning aid is configured as a hand held device and includes a handle.

31. The cleaning aid according to claim 22, wherein the cleaning aid is configured as a standing device and includes a frame having legs supporting the frame on the ground and wherein the surface is supported by the frame.
